(19) United States
(12) Patent Application Publication
(10) Pub. No.: US 2008/0308123 A1
(43) Pub. Date: Dec. 18, 2008

(54) MOWER DECK MAINTENANCE DEVICE SYSTEM AND METHOD

(76) Inventor: James D. Slinker, Aubrey, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/139,412

(22) Filed: Jun. 13, 2008

Related U.S. Application Data
(60) Provisional application No. 60/934,372, filed on Jun. 13, 2007.

(51) Int. Cl. B08B 1/00

(52) U.S. Cl. 134/8

(57) ABSTRACT

A system and method to remove debris from a mower deck having a plurality of cooperating elements, the elements including a scraping tool to loosen the debris from the mower deck, a spray tool to wash the debris from the mower deck, and mower stands to support the mower deck during maintenance of the mower deck and to guide the spray tool.

### CROSS-REFERENCE TO RELATED APPLICATION

This application for patent claims the benefit of priority from U.S. Provisional Patent Application Ser. No. 60/934,372 filed Jun. 13, 2007, the disclosure of which is incorporated herein by reference in its entirety.

### BACKGROUND OF THE INVENTION

1. Field of the Invention

The present general inventive concept relates to a system and method to maintain lawn-mower decks, and in particular, to a system and method that employs a plurality of cooperating devices to facilitate cleaning, conditioning, and other like maintenance task for lawn-mower decks and the like.

2. Description of the Related Art

One of the most common household machines includes a lawn mower, which is used to trim a lawn. The lawn mower, whether it be a riding lawn mower or a push/self-propelled lawn mower, generally includes a mower deck that partially surrounds a top and sides of a mower deck cutting blade. In use, the cutting blade rotates inside the mower deck and cuts through grass and other debris as the lawn mower moves around the lawn.

When the lawn mower cuts through debris, some of the debris becomes stuck to an inner side of the mower deck, which requires removal to prevent corrosion of the mower deck and cutting blade.

Therefore, it is desirable to provide a system and method for maintaining a mower deck that is easy to use, inexpensive to manufacture, and affords a user with a certain degree of versatility.

### SUMMARY OF THE INVENTION

The present general inventive concept provides a system and method for maintaining a mower deck using a plurality of cooperating mower deck maintenance devices.

Wherein the plurality of cooperating mower deck maintenance devices are simple to use, inexpensive to manufacture, and afford a user with versatility so that the devices have a plurality of use options.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a mower deck with an interior having accumulated debris, scraping the interior with a cleaning tool to loosen the debris, positioning first and second mower-deck stands having first and second apertures on either side of the mower deck, lowering the mower deck onto the first and second mower-deck stands, and inserting a washing tool through the first and second apertures of the first and second mower-deck stands.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a front elevation view of the exemplary embodiment of the present general inventive concept illustrating a mower deck supported on mower-deck stands, a cleaning tool engaged with the mower deck, a washing tool 20 extended through the mower deck stands.

FIG. 2 is a front elevation view of the exemplary embodiment of the present general inventive concept illustrated in FIG. 1 with the cleaning tool engaged with the mower deck.

FIG. 3 is a front elevation view of the washing tool of the present general inventive concept.

FIG. 4 is a front elevation view of the cleaning tool of the present general inventive concept.

FIG. 5 is a perspective view of the mower deck stands of the present general inventive concept.

FIG. 6 is a front elevation view of the exemplary embodiment of the present general inventive concept illustrating a mower deck supported on mower-deck stands having a magnetic connector to connect the mower-deck stands to the mower deck and allow the mower deck and mower-deck stands to be simultaneously lowered to engage a ground surface.

FIG. 7 is a front elevation view of the exemplary embodiment of the present general inventive concept illustrating a mower deck supported on mower-deck stands having a lip connector to connect the mower-deck stands to the mower deck and allow the mower deck and mower-deck stands to be simultaneously lowered to engage a ground surface.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures

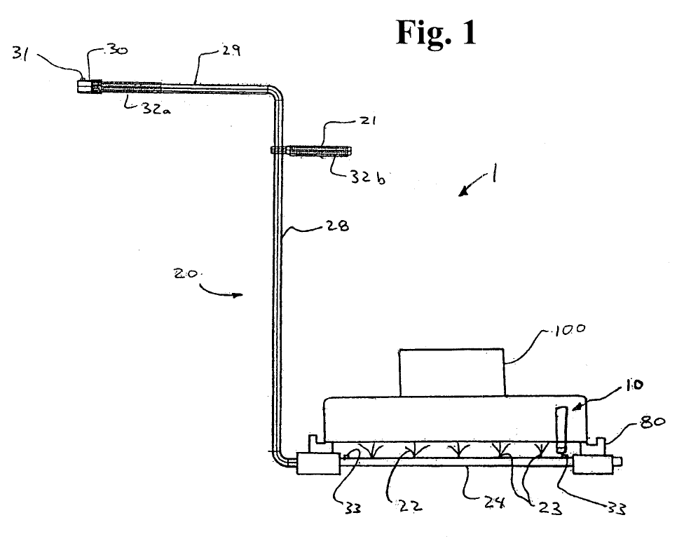

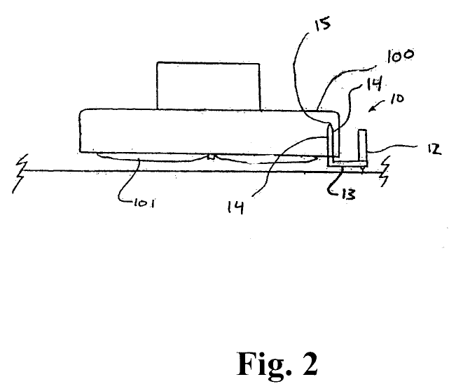

The present general inventive concept, as illustrated in FIGS. 1 and 2, includes a plurality of cooperating lawn-mower deck maintenance devices 1 for a maintenance operation including a cleaning tool 10, such as a hand scraper, to loosen and remove debris accumulated within and around a mower deck 100; a washing tool 20, such as a wand attachment for a garden hose to further remove debris accumulated within and around the mower deck 100; and (3) mower-deck stands 80 to engage and thereby securely support the mower deck 100 and coordinate with the washing tool 20 during a maintenance operation.

Using these lawn-mower deck maintenance devices 1 with nothing more than a standard connection to a garden hose (not illustrated), a user has the ability to perform multiple functions to perform routine cleaning, maintenance, high pressure cleaning, and conditioning of a lawn mower deck. Additional uses and applications will be apparent to those of ordinary skill in the art.

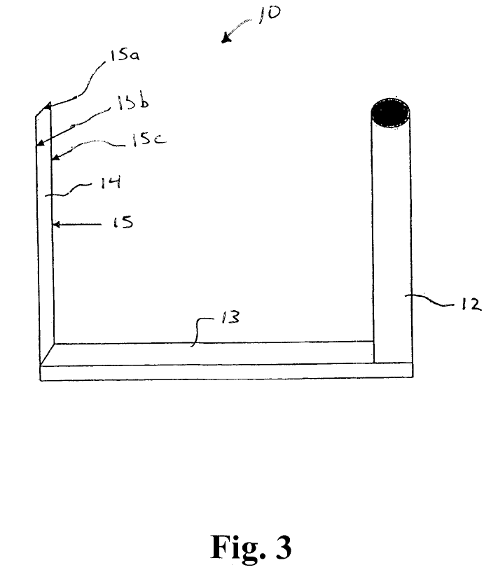

The cleaning tool 10, as illustrated in FIG. 3, has a U-shaped body with a handle 12, an extension 13, and a sharpened, dual-sided blade 14. In the exemplary embodiment, the dual-sided blade 14 has a pointed top surface 15, thus providing the cleaning tool 10 with up to three sharpened edges.

The unique U-shape of the cleaning tool 10 enables the user to conveniently gain access to the underside of the mower deck 100 to clean the mower deck 100 while maintaining a safe distance from a mower-deck blade 101. The cleaning tool 10 can be used to safely scrape under the mower deck 100 and around a mower-deck blade 101 to loosen and remove accumulated debris without requiring the user to reach underneath the mower deck 100, which may result in injury as well as stained hands and/or clothing.

The dual-sided blade 14 enables the user to penetrate the debris with the pointed top surface 15 via an upward thrusting movement and to separate the debris from the mower deck 100 with the dual-sided blade 14 via a lateral thrusting movement, relative to the ground surface. A further description of the use of the cleaning tool 10 during the mower deck maintenance operation is provided hereafter.

In the exemplary embodiment, the handle 12 of the cleaning tool 10 may be made of aluminum to deter rust thereby ensuring longevity and may be connected to the extension 13 via a bolt, weld, or glue.

The extension 13 and dual-sided blade 14 may be made of a metal, such as stainless steel, to enable sharpening of each side of the dual-sided blade 14 and the pointed top surface 15. The extension 13 may be integral with the dual-sided blade 14, in which case, the extension 13 is bent at an angle to form lower and side portions, which cooperate with the handle to form the cleaning tool 20.

It is foreseen that the cleaning tool 10 may be made of other materials with similar properties and may be made entirely or partially of steel, aluminum, and in some cases, plastic. Further, the cleaning tool 10 may be powder coated.

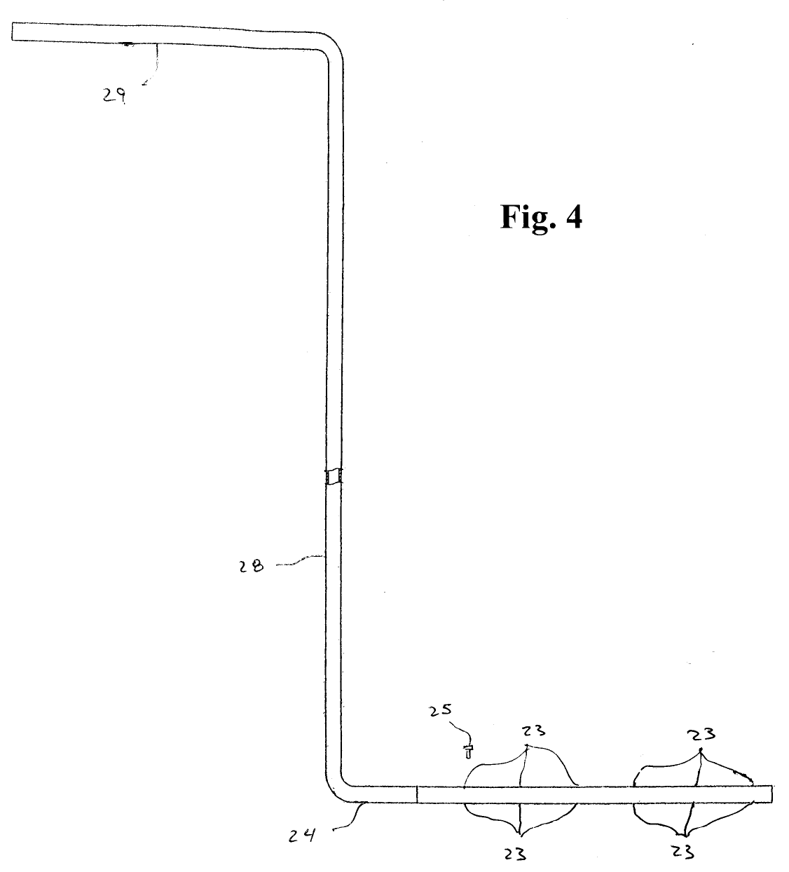

The washing tool 20, illustrated in FIG. 4, has three primary elements, i.e., a wand lower portion 24, a wand central portion 28, and a wand top portion 29.

Attached to the wand central portion 28 via a clasp 27 is a uniquely designed handle 21 that is adjustable so that the user may change a projection direction of a spray 22. The spray 22 projects from apertures 23 situated along the wand lower portion 24 of the washing tool 20. The direction of the spray 22 is easily manipulated by loosening the handle 21 and the clasp 27 so that the handle may be rotated clockwise or counter clockwise to redirect the flow of water.

The user may also adjust water pressure and spray direction by simply adding or removing stainless steel screws to block one or more of the apertures 23 that may be located on anywhere along the wand lower portion 24, which is discussed in detail hereafter.

In the exemplary embodiment, the wand lower portion 24, wand central portion 28, wand top portion 29 and handle 21 of the washing device 20 may be made of aluminum to deter rust thereby ensuring longevity. Such material may be 6063-T5 aluminum tubing having a 0.8120 inch outer diameter and a 0.625 inch inner diameter. Alternatively, the body may be made of 3003 aluminum, which is particularly useful for attachment to pressure washers up to 2500 psi. The aluminum tubing may be a single piece of material that is bent at 90 degrees in two places to form the wand lower portion 24, wand central portion 28, wand top portion 29.

The exemplary embodiment is particularly useful for attachment to a typical garden hose (not illustrated) via a hose-adaptor portion 30. The hose-adaptor portion 30 is located in an end of the wand top portion 29 and may be made of plastic. Additionally, high grade rubber may be used for grips 32a and 32b, respectively located on the wand top portion 29 and on the handle 21 attached to the wand central portion 28. In the exemplary embodiment, the hose connection may include a shut-off valve 31 to turn on, off, and/or adjust a flow of water into the attachment of the present general inventive concept.

Pressure screws 33, as discussed above with respect to the exemplary embodiment, may be either inserted in or removed from the apertures 23, which may be threaded, to adjust pressure and/or spray direction, and may be made of stainless steel. The exemplary embodiment employs a garden hose, #10 size screws and associated #10 size threaded holes in the wand lower portion 24. It will be appreciated that alternative sizes of the apertures 23 and corresponding screw sizes 33 may be utilized to provide a desired water flow rate/pressure through each of the apertures 23 in the wand lower portion 24. For example, all apertures 23 and corresponding screws may be #8 size, i.e., slightly smaller in diameter than #10, for slightly increased pressure, #6 for even greater pressure, and #4 for highest pressure applications.

Furthermore, it will be appreciated that apertures 23 of varying sizes may be located in the wand lower portion 24 to allow the user to selectively add or remove screws 33 of a certain size to create the desired pressure. In addition, it will be appreciated that in place of screws 33, adjustable or fixed nozzle tips may be utilized in connection with each of the apertures 23. A further description of the use of the washing tool 20 during the mower deck maintenance operation is provided hereafter

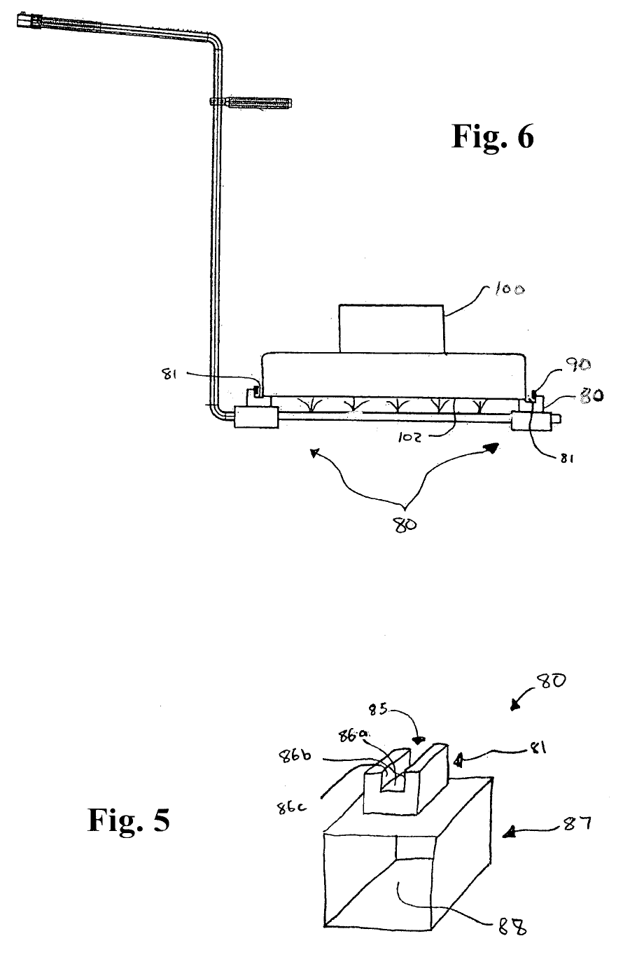

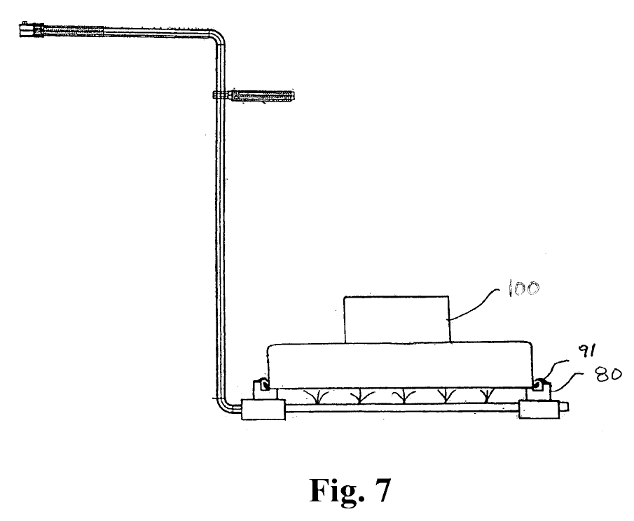

FIGS. 6 and 7 illustrate the mower-deck stands 80 with one of the mower deck stands 80 illustrated in detail in FIG. 5. The mower deck stands 80 are identical and have an elongated, rectangular hollow base portion 87 with a correspondingly-sized rectangular, hollow upper portion 81. The upper portion 81 is perpendicularly mounted at a central location of the base portion 87.

The mower-deck stands 80 are positioned to engage either side of the mower deck 100 so that the mower deck 100 is securely supported on the ground. The mower-deck stands 80 maintain a predetermined distance between the mower deck 100 and the ground surface during the maintenance operation.

While the exemplary embodiment of the mower-deck stands 80 are made of metal, other material may be used that is capable of supporting the weight of the mower deck 100, such as aluminum or plastic.

Each upper portion 81 of the mower decks stands 80 have a U-shaped mower-deck engagement portion 85 with a flat surface 86a and two side walls 86b and 86c that are sized to engage a mower deck lower surface 102. The flat surface 85 and two side walls 86 are designed to partially wrap around the lower mower deck lower surface 102. While the exemplary embodiment utilizes the U-shaped mower-deck engagement portion 85, the shape of the engagement portion 85 is not limited thereto and may assume a shape corresponding to the mower deck 100 to facilitate secure engagement therebetween.

In use, the mower-deck stands 80 are placed under the mower deck 100 and spaced from each other so that the mower deck 100 may be lowered onto the mower-deck stands 80 and the engagement portion 85 thereof. The mower-deck stands 80 may also be equipped with a mower-deck connector such as a magnet 90, as illustrated in FIG. 6, or lip 91, as illustrated in FIG. 7. The mower-deck connectors 90 or 91 permit the mower-deck stand 80 to be attached to the mower deck 100 so that the mower deck and mower-deck stands 80 may be lowered simultaneously. On the base portion 87 of the mower-deck stands 80 is a first washing-tool engagement aperture 88 sized to permit the washing tool 20 to pass therethrough.

In the exemplary embodiment, the mower-deck stands 80 are identical and are situated on a mower-deck sides opposite to each other to cooperate therewith. While the exemplary embodiment utilizes a pair of mower-deck stands 80, any number of mower-deck stands 80 may be used depending on factors including, but not limited to, mower-deck size, amount of accumulated debris within the mower deck, and intended use by the user.

Each of the mower-deck stands 80 have the washing-tool engagement aperture 88 to accommodate and secure either end of the wand lower portion 24 of the washing tool 20. In this manner, each washing-tool engagement aperture 88 cooperates to provide a restrictive boundary so that when the washing tool is inserted into the engagement aperture 88 of one of the mower-deck stands 80, extended under the mower deck 100, and inserted into the engagement aperture 88 of another of the mower-deck stands 80, each aperture 88 ensures the washing tool 20 maintains a safe distance away from the mower deck 100 and mower-deck blade 101.

Upon engagement of the washing tool with the mower-deck stands 80, the washing tool 20 and the mower-deck blade 101 may be activated. The mower-deck blade 101 facilitates cleaning of the mower deck 100 in that as water is directed upwards from the washing tool 20, the water contacts the mower-deck blade 101, which projects and disperses the water internally within the mower deck 100. The rotational movement of the mower-deck blade 101 generates a centripetal force, which increases the velocity with which the water is projected, thus facilitating the removal of debris and the efficiency of the maintenance operation.

While the mower-deck stands 80 may be moved to various positions with respect to the mower deck 100, the exemplary embodiment positions the mower-deck stands 80 at a central location with respect the mower deck 100.

Regarding the description of the mower-deck maintenance operation and the use of the cleaning tool 10, the washing tool 20, and mower-deck stand 80, the operation may include, but is not limited to the following, which may be performed in varying order, omitted, and/or repeated as desired by the user: (1) providing a mower deck 100 with accumulated debris in a rest/off position on a flat ground surface; (2) scraping the mower deck 100 with the cleaning tool 20 to loosen and remove as much debris as possible via upward and lateral movements; (3) pre-treating the mower deck 100 by activating and extending the washing tool 20 under the mower deck 100 to project water upwards and into the mower deck 100 to further remove as much debris as possible; (4) positioning the mower-deck stands 80 on either side of the mower deck 100 in a central location thereto; (5) lowering the mower deck 100 onto the mower-deck stands 80; (6) sequentially inserting the washing tool 20 through the engagement aperture 88 of the mower-deck stands 80; (7) activating the mower-deck blade 101; (8) activating the washing tool 20; (9) permitting the activated mower-deck blade 101 to run for an amount of time sufficient to remove all debris from the mower deck 100, e.g., 5 minutes; (10) deactivating the mower-deck blade 101; (11) deactivating the washing tool 20; (12) removing the washing tool 20 from the engagement aperture 88 of the mower-deck stands 80; (13) raising the mower deck 100 off the first and second mower-deck stands 80; (14) providing the mower deck 100 in a rest/off position free from debris.

In the exemplary embodiment, the washing tool 20 may be connected to a water hose (not illustrated) having a water source so that a water stream can be directed into the washing tool 20. The washing tool 20 may manage a plurality of washing stages by at least one canister (not illustrated) that may be integral with the washing tool 20 or connected to the washing tool 20 via an adapter to allow for an injection into the water stream.

Preferably, the canister adapter is located downstream from the shut-off valve 31 so that the shut-off valve 31 may deactivate the water stream to facilitate replacement of the canister. The plurality of stages may be managed by connecting a different canister for each stage or by a canister with a plurality of reservoirs that are accessed via a secondary switch. The plurality of stages may include, but are not limited to the following stages, which may be performed in varying order, omitted, and/or repeated as desired by the user: (1) a pre-treatment stage whereby water is applied without activating the canister to loosen and remove debris; (2) a wash stage whereby a combination of water and a canister with a cleaning agent is applied to the mower deck 100 to thoroughly wash and degrease the mower deck 100; (3) a rinse stage whereby water is applied without a canister to remove the cleaning agent; (4) a dry stage whereby air is; and (5) a post-treatment stage whereby a canister with a conditioning agent is applied with water to coat the interior of the mower deck 100 with at least one conditioning agent to increase the lifespan of the mower deck 100, e.g., via a rust deterrent, and decrease the frequency of further maintenance operations, e.g., via a debris-collection deterrent.

While the exemplary embodiment utilizes a water hose (not illustrated) to connect with the washing tool 20, other fluid hoses may be used in lieu of a water hose or in combination therewith. For example, water and air hoses may be interchangeably connected to the washing tool 20 or a dual-fluid stream hose may be utilized wherein either liquid or gas are managed via a switch. In the case where a dual-fluid stream hose is employed, the shut-off valve 31 may alternate between fluids or provide a plurality of mixtures thereof. For instance, the user may find it beneficial to manipulate the post-treatment stage with a mixture of liquid and gas, e.g., ten percent liquid and 90 percent gas.

The foregoing and/or other objects are intended to be illustrative of the present general inventive concept and are not meant in a limiting sense. Many possible embodiments of the present general inventive concept may be made and will be readily evident upon a study of the following specification and accompanying drawings including a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept.

What is claimed is:

1. A method for removing debris, the method comprising:
providing a mower deck with an interior having accumulated debris;
scraping the interior with a cleaning tool to loosen the debris;
positioning first and second mower-deck stands having first and second apertures on either side of the mower deck;
lowering the mower deck onto the first and second mower-deck stands; and
inserting a washing tool through the first and second apertures of the first and second mower-deck stands.
